(19) United States
(12) Patent Application Publication
(10) Pub. No.: US 2025/0168132 A1
(43) Pub. Date: May 22, 2025

(54) COLLABORATIVE INTERACTION SYSTEM AND METHOD FOR DELEGATING AND MONITORING TASKS OF A CHATBOT

(71) Applicant: Wei-Cheng KUO, San Jose, CA (US)

(72) Inventor: Wei-Cheng KUO, San Jose, CA (US)

(21) Appl. No.: 18/516,892

(22) Filed: Nov. 21, 2023

(51) Int. Cl. H04L 51/02; H04L 51/52

(52) U.S. Cl. CPC H04L 51/02; H04L 51/52

(57) ABSTRACT

The collaborative interaction system for delegating and monitoring tasks of a Chatbot comprises a computing device having at least one processor a memory to store instructions that are executable by the processor. The computing device is in communication with an application server through a network. In particular, the collaborative interaction system enables a user to access a chatroom by providing user credentials through a user interface of the computing device. The system assigns at least one artificial intelligence (AI) agent of a plurality of AI agents and receive one or more tasks from the user through the user interface. The system analyzes the one or more tasks through a moderator agent for dividing into a plurality of sub-tasks. The system delegates each sub-task of the plurality of sub-tasks to at least one intelligent agent of a plurality of intelligent agents for effective execution of the each sub-task.

### FIELD OF THE INVENTION

The present disclosure relates generally to collaborative systems, and more particularly to a system capable of processing varied inputs, conducting task planning, and executing the tasks based on user directives using multiple artificial intelligence (AI) agents.

### BACKGROUND

Users may establish communication with a service provider via communication channels to seek for information. Digital assistant such as chatbots simulate conversation with humans. Digital assistants are often used in customer service applications, where they can answer questions, provide support, and resolve issues. Digital assistants can also be used for education, entertainment, and other purposes. There are two main types of Digital assistants that include rule-based and machine learning-based for generating responses. Rule-based digital assistants follow a set of rules to generate responses. Machine learning-based digital assistants use artificial intelligence to learn from their interactions with users and improve their responses over time.

Digital assistants are becoming popular as a way to provide customer service. Digital assistants can be available every time and can answer questions quickly and accurately. Digital assistants can also be used to automate tasks, such as sending out order confirmations or tracking shipments. Some of the benefits of using digital assistants are convenience, speed, efficiency, accuracy and personalization. The aim is for the digital assistant is to accurately understand a user query and to respond accordingly, for example, by returning a relevant response, or completing a task or action. Previously, the user may have carried out this interaction via an application that is installed in a mobile device.

A challenge in optimizing the digital assistant can be tailoring the digital assistant to match the natural language processing (NLP) engine being utilized. Sometimes, digital assistants may also experience “fallout,” i.e., instances when the NLP algorithm does not succeed in matching the end user's utterance to an intent. Back-up techniques, such as asking the end user to rephrase a question, may result in an unpleasant user experience. Similarly, a bad user experience may result when the NLP algorithm makes the wrong match. Without a continuous feeding and learning process to improve digital assistant pattern matching, fallouts and wrong matches may re-occur, and user experiences may quickly deteriorate.

In existing technology, a chatbot system is known. The chatbot includes a parent chatbot and a plurality of sub-chatbots. Each sub-chatbot is assigned to a distinct domain. The parent chatbot has been modified to accept user queries and direct them to the appropriate sub-chatbot. Each sub-chatbot contains at least one chatbot dialogue and is programmed to answer the user query with the help of at least one chatbot dialogue. However, the chatbot system provides answers to the queries given by the user as it is programmed. There is a need for a collaborative interaction system that communicates with the user efficiently so as to provide an effective answer.

Therefore, there is a need for a collaborative interaction system that enhances versatility and applicability across different domains. There is a need for a collaborative interaction system that automates regular operations, assures accurate execution, allows users to concentrate on strategic activities, and potentially increases total productivity. In addition, there is a need for a collaborative interaction system that reduces time and operational costs. Further, there is a need for a collaborative interaction system that adapts to increasing user, task, and agent numbers and ensures long-term usefulness and market share.

### SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key nor critical elements of all embodiments, nor delineate the scope of any or all embodiments.

The present disclosure, in one or more embodiments, relates to a collaborative interaction system method for delegating and monitoring tasks of a Chatbot. In one embodiment herein, the collaborative interaction system for delegating and monitoring tasks of the Chatbot comprises a computing device. In particular, the computing device having at least one processor. The computing device is in communication with an application server through a network, and a memory in communication with the processor and configured to store instructions that are executable by the processor.

In one embodiment herein, the processor is configured to execute stored instructions to cause the collaborative interaction system. The processor is configured to enable a user to access a chatroom by providing user credentials through a user interface of the computing device.

The processor is configured to assign at least one artificial intelligence (AI) agent of a plurality of AI agents and receive one or more tasks from the user through the user interface. In specific, the one or more tasks includes data related to at least one of text, images, video data, audio data, digital video data, and digital audio data. The collaborative interaction system is configured to enable the user to upload at least one or more data files related to one or more tasks. In particular, the one or more data files include at least one of a word document, one or more images, video files, spreadsheets, and audio files.

The processor is configured to analyze the one or more tasks through a moderator agent for dividing into a plurality of sub-tasks. The processor is configured to delegate each sub-task of the plurality of sub-tasks to at least one intelligent agent of a plurality of intelligent agents for effective execution of the each sub-task. In specific, the plurality of intelligent agents is configured to interact with each other and the user for clarifications and additional information of the each sub-task during the execution of the each sub-task.

The processor is configured to enable the plurality of intelligent agents to interact with each other and the user for clarifications and additional information of the each sub-task during the execution of the each sub-task. The collaborative interaction system enables the user to interact for altering the execution of the one or more tasks based on updates received in real-time.

The collaborative interaction system is configured to generate a summarized report for the user to approve through the user interface upon completion of the each sub-task by the plurality of intelligent agents. The collaborative interaction system is configured to enable the user to provide a feedback through the user interface. In specific, the feedback include haptic, visual, and auditory feedback. The collaborative interaction system comprises a database in communication with the processor configured to store data related to the user.

An embodiment of the first aspect wherein a method for delegating and monitoring tasks of a chatbot using a collaborative interaction system. At one step, the collaborative interaction system enables the user to access a chatroom by providing user credentials through the user interface of the computing device. At one step, the collaborative interaction system assigns at least one artificial intelligence (AI) agent through the processor of the plurality of AI agents and receive one or more tasks from the user through the user interface.

At one step, the collaborative interaction system analyzes the one or more tasks through the moderator agent for dividing into the plurality of sub-tasks. At one step, the collaborative interaction system delegating each sub-task of the plurality of sub-tasks to the at least one intelligent agent of the plurality of intelligent agents through the processor for effective execution of the each sub-task. The collaborative interaction system further enables the plurality of intelligent agents through the processor to interact with each other and the user for clarifications and additional information of the each sub-task during the execution of the each sub-task.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

The accompanying drawings, which are incorporated in and constitute a part of the specification, illustrate an embodiment of the invention, and, together with the description, explain the principles of the invention.

FIG. 1 illustrates a block diagram of a collaborative interaction system, in accordance with embodiments of the invention.

FIG. 2 illustrates a flowchart of a collaborative interaction system, in accordance with embodiments of the invention.

FIG. 3 illustrates a flowchart of a method for operating a collaborative interaction system, in accordance with embodiments of the invention.

### DETAILED DESCRIPTION

Reference will now be made in detail to the present preferred embodiments of the invention, examples of which are illustrated in the accompanying drawings. Wherever possible, the same reference numerals are used in the drawings and the description to refer to the same or like parts.

In one embodiment herein, a chatbot is a software application or web interface that aims to mimic human conversation through text or voice interactions. Modern chatbots are typically online and use artificial intelligence (AI) systems that are capable of maintaining a conversation with a user in natural language and simulating the way a human would behave as a conversational partner.

Such technologies often utilize aspects of deep learning and natural language processing, but more simplistic chatbots have been around for decades prior. Chatbots are used in a wide variety of applications, including customer service, education, entertainment, and healthcare. They can provide a convenient and efficient way for people to interact with businesses and organizations, and they can also be used to provide information, answer questions, and complete tasks.

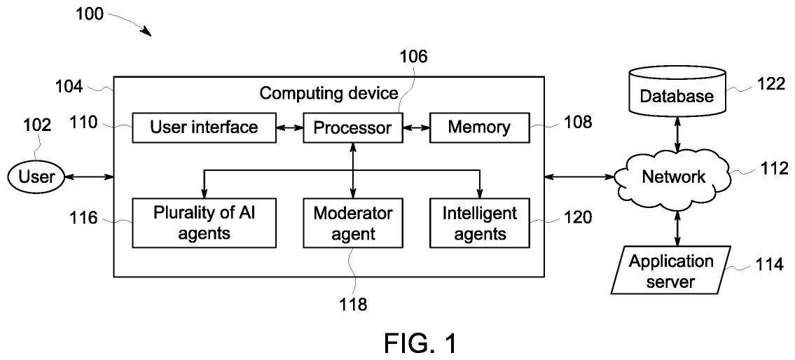

FIG. 1 refers to a block diagram of a collaborative interaction system 100 for delegating and monitoring tasks of the Chatbot. In one embodiment herein, the collaborative interaction system 100 is configured to process various inputs, conduct task planning and execute tasks based on user directives using multiple artificial intelligence (AI) agents. The collaborative interaction system 100 comprises a computing device 104.

In one embodiment herein, the computing device 104 having at least one processor 106 and a memory 108 in communication with the processor 106. The memory 108 is configured to store instructions that, when executed by the processor 106. In addition, the processor 106 is configured to dynamically interact with an artificial intelligence (AI) in real-time. The computing device 104 includes at least one of a smartphone, a tablet, a computer and a laptop thereof. In one embodiment herein, the computing device 104 is in communication with an application server 114 through a network 112. In an embodiment herein, the network 112 could be, but is not limited to, Wi-Fi, Bluetooth, a wireless local area network (WLAN)/Internet connection, and radio communication. In some embodiments, the computing device 104 could be touchscreen and/or non-touchscreen and adopted to run on any type of OS, such as iOS, Windows, Android, Unix, Linux and/or others.

In one example embodiment herein, the application server 114 could be a server work as an intermediary between one or more databases 122, which store application data and the user data. In an embodiment herein, the application server 114 is at least one of a general or special purpose computer. The application server 114 could be operated as a single computer, which can be a hardware and/or software server, a workstation, a desktop, a laptop, a tablet, a mobile phone, a mainframe, a supercomputer, a server farm, and so forth.

In one embodiment, the processor 106 is designed to execute stored instructions that allow the collaborative interaction system 100 to perform various operations. These operations include enabling a user 102 to access a chatroom by providing their credentials through a user interface 110 on their computing device 104. The collaborative interaction system 100 also assigns at least one artificial intelligence (AI) agent from a group of AI agents 116 and receives one or more tasks from the user 102 through the same interface 110. The tasks are analyzed through a moderator agent 118, which divides them into multiple sub-tasks. Each sub-task is then delegated to at least one intelligent agent from a group of intelligent agents 120 to ensure effective execution. In one embodiment herein, the moderator agent 118 could be the AI agent.

In one embodiment herein, the AI agents, the moderator agent 118 and the intelligent agents 120 use artificial intelligence to simulate conversation with human users. The AI agents, the moderator agent 118 and the intelligent agents 120 are typically powered by natural language processing (NLP) and machine learning (ML), which allow them to understand and respond to human language in a natural and engaging way.

In another embodiment herein, the processor 106 of the collaborative interaction system 100 is an essential component that executes stored instructions to perform various operations. One of the prime functionalities of the collaborative interaction system 100 is to enable the user 102 to access the chatroom. This is done by providing user credentials through the user interface 110 of the computing device 104.

Once the user 102 logs in, the system 100 assigns at least one artificial intelligence (AI) agent from the group of AI agents 116 to receive one or more tasks from the user 102. These tasks are then analyzed by the moderator agent 118, which divides them into multiple sub-tasks based on their complexity and nature. This analysis assists in the efficient execution of the tasks. The collaborative interaction system 100 extends capabilities to edge devices, allowing for real-time data collecting and actions in physical surroundings, effectively integrating the digital and physical operating worlds.

Each sub-task is delegated to at least one intelligent agent from a group of intelligent agents 120 to ensure effective execution of the tasks. These intelligent agents 120 possess specific skills, expertise, and experience, which they utilize optimally to perform the delegated sub-tasks. This delegation process enables the system 100 to handle complex and diverse tasks seamlessly, enhancing efficiency and productivity. The collaborative interaction system 100 could be an ideal system for organizations and individuals looking to streamline their work processes and increase productivity. In one embodiment herein, the plurality of intelligent agents 120 could be specialized agents and the AI agents.

In one embodiment herein, the intelligent agents 120 are configured to interact with each other and the user 102 for clarifications and additional information of the each sub-task during the execution of the each sub-task. In one embodiment herein, the collaborative interaction system 100 enables the user 102 to interact for altering the execution of the one or more tasks based on updates received in real-time. The collaborative interaction system 100 is configured to generate a summarized report for the user 102 to approve through the user interface 110 upon completion of the each sub-task by the plurality of intelligent agents 120. The collaborative interaction system 100 is configured to enable the user 102 to provide a feedback through the user interface 110. In one embodiment herein, the feedback includes haptic, visual, and auditory feedback.

In one embodiment herein, the collaborative interaction system 100 further comprises a database 122 that is in communication with the processor 106 and configured to store data related to the user 102. In one embodiment herein, the one or more tasks includes data related to at least one of text, images, video data, audio data, digital video data, and digital audio data.

In one embodiment herein, the database 122 is in communication with the application server 114 via the network 112. The database 122 is configured to receive and store the application data and the user data including texts, images, audios, and videos. In an embodiment herein, the database 122 may be accessible by the application server 114. The database 122 may be integrated into the application server 114 or separate from it. In some embodiments, the database 122 resides in the connected application server 114 or a cloud computing service. Regardless of location, the database 122 comprises a memory to store and organize the application data and the user data including texts, images, audios, and videos for use by the application server 114.

In another embodiment, the collaborative interaction system 100 is a computer system or a platform that enables multiple users 102 to work together on a project or task. It includes the database 122 that is connected to the processor 106 and is designed to store data related to the user 102, such as personal information, preferences, and work history. The processor 106 is programmed to manage and coordinate the tasks performed by the users 102, and to provide feedback and guidance as necessary.

In another embodiment, the collaborative interaction system 100 may involve tasks that require the use of various media formats, such as text, images, videos, audio, digital video, and digital audio data. The system 100 is capable of processing and handling these formats to facilitate the collaboration between the users 102 and ensure that the tasks are completed efficiently and effectively.

In one embodiment, the collaborative interaction system 100 is configured to perform human-centric task delegation process for assigning various tasks to the AI agents in a way that is mindful of human capabilities, limitations, and preferences. This approach aims to strike a balance between automation and human involvement, ensuring that AI agents and enhances human work.

In one embodiment herein, the collaborative interaction system 100 is configured to enable the user 102 to upload at least one or more data files related to one or more tasks. The one or more data files include at least one of a word document, one or more images, video files, spreadsheets, and audio files. The processor 106 enables the user 102 to modify subtask execution or reassign the each subtask to different specialists on-the-fly. The collaborative interaction system 100 ensures secure communication and data protection when working with the plurality of specialists.

The processor 106 collects feedback from the user 102 based on summarized task for improving performance of the collaborative interaction system 100. In specific, the collected feedback is stored in the database 122 for enhancing the performance of the collaborative interaction system 100. In one embodiment herein, the collaborative interaction system 100 is designed to accommodate multiple users, agents and tasks. The collaborative interaction system 100 enables real-time feedback and dynamic task management improve task accuracy and efficiency. The collaborative interaction system 100 reduces manual task management, time consumption and costs.

In some embodiment herein, the user 102 can be attracted due to intuitive and human-centric design. For example, if the user 102 provides basic data then the collaborative interaction system 100 has a capability to execute and provide the summarized task to the user 102 for reviewing. The collaborative interaction system 100 adapts to increasing user, task, and agent numbers and ensures long-term usefulness and market share.

In one embodiment herein, the collaborative interaction system 100 performs operations automatically after receiving the one or inputs from the user 102 and completes the assigned task effectively so as to assists the user 102 to concentrate on strategic activities, and potentially increases total productivity. In addition, the collaborative interaction system 100 enhances versatility and applicability across different domains.

In one embodiment herein, the collaborative interaction system 100 interfaces with edge devices so as to develop Internet of Things (IoT) industry and enables to utilize in smart homes, smart cities, and industrial automation industries. The collaborative interaction system 100 may respond to real-world events in real-time using edge device integration, provide commercial advantages in circumstances requiring fast action, thereby potentially reducing response times and associated costs.

In one example embodiment herein, the chatbots can be used to answer customer questions about products or services, troubleshoot problems, and process orders. For education, the chatbots can be used to provide personalized instruction, answer questions, and grade assignments. For entertainment, the chatbots can be used to play games, tell stories, and provide companionship. In addition, the chatbots can be used to collect patient information, schedule appointments, and provide health information for health care purposes. Chatbots are a rapidly growing technology, and their use is likely to continue to expand in the years to come. As AI technology continues to develop, chatbots may become more sophisticated and capable of interacting with humans in increasingly natural ways.

The collaborative interaction system 100 is designed to support a variety of inputs and output modalities, such as text, speech, and video. It is also designed to support multiple AI agents working together on the same task assigned through the processor 106. The collaborative interaction system 100 uses human-centric task delegation and monitoring, which means that it allows the processor 106 to delegate tasks to the AI agents and monitor the status of the tasks. This can help to improve productivity and efficiency.

The collaborative interaction system 100 is designed to be flexible and extensible. In an example embodiment herein, the collaborative interaction system 100 can be used to support a wide variety of tasks, from simple tasks, for example, booking a flight to complex tasks like planning a business trip, customer services, Sales and marketing, Healthcare, Entertainment, Government and public sector and Internal business processes. The collaborative interaction system 100 can also be extended to support new AI techniques and modalities.

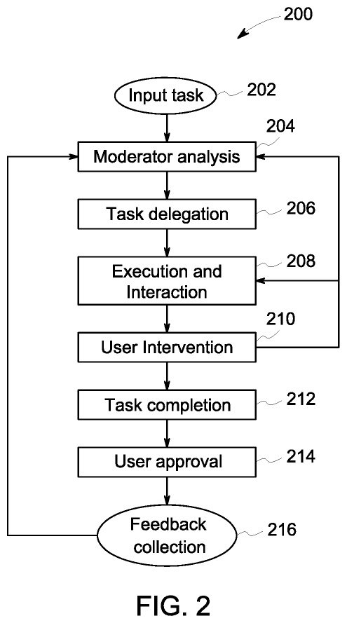

FIG. 2 refers to a flowchart 200 of the collaborative interaction system 100 for delegating and monitoring tasks of the Chatbot. The flowchart 200 begins with the user 102 creating a task using natural language, text, images, or sound within the computing device 104 via the user interface 110 at step 202. The user interface 110 can be the chatroom interface. This flexibility caters to diverse user preferences and communication styles, thereby ensuring that the user 102 can effectively input task requests to the collaborative interaction system 100. For example, the user 102 may simply enters the input task requests to the collaborative interaction system 100 using natural language processing (NLP) capabilities through speaking. This conversational approach allows for intuitive and hands-free task creation, particularly for those who prefer verbal communication.

In another example, the collaborative interaction system 100 may provide a user-friendly interface for typing task descriptions for those who prefer traditional text-based input. This method offers precision and clarity to ensure that the task requirements are accurately captured. In another example, the user 102 may also create tasks by uploading images or providing visual references. This feature is particularly useful for tasks involving design, aesthetics, or specific objects. In another example, the user 102 may create tasks by uploading audio files or providing voice recordings. This method is particularly useful for tasks related to music, soundscapes, or auditory feedback.

At step 204, the moderator agent 118 or the processor 106 orchestrates the task execution process by analyzing the task, creating an actionable plan, and assigning subtasks to specialized agents. This step is essential for ensuring that the task is divided into manageable subtasks. Here, the each subtask is assigned to the specialized agent with the most relevant expertise. To effectively perform this role, the processor 106 leverages its knowledge of the specialized agents' capabilities and the nature of the task.

The processor 106 carefully considers the task's requirements, the available resources, and the potential dependencies between the subtasks. Based on this analysis, the processor 106 creates a step-by-step plan that outlines the order in which the subtasks should be completed. This plan serves as a roadmap for the specialized agents to work collaboratively towards achieving the overall task goal.

After the plan is in place, the processor 106 assigns each subtask to the suitable specialized agent for handling. This assignment process takes into account the specific expertise and skills of each agent, as well as their current workload and availability. The processor 106 optimizes the task execution process and maximizes the likelihood of success by carefully matching the subtasks to appropriate specialized agents.

At step 206, the specialized agents interact with one another or the user 102 for clarification or additional information, thereby ensuring that the specialized agents are carrying out the subtasks correctly and efficiently. This collaboration between agents and users 102 is essential for handling complex tasks and achieving the desired outcomes. For example, an agent might request clarification from the user 102 about the task requirements. In another example, an agent might seek assistance from another agent for a particular subtask. In another example, an agent might provide updates to the user 102 about the progress of the subtask. This allows the user 102 to stay informed about the task's progress and identify any potential issues early on. In another example, an agent might request additional information from the user 102 if the agent encounters an unexpected obstacle in executing the task.

At step 208, the live feed within the computing device 104 displays a real-time view of the task progress, thereby enabling the user 102 to oversee and intervene in real-time. This feature is crucial for keeping the user 102 informed about the task's progression and allowing the user 102 to make adjustments or provide feedback as needed. The live feed typically shows a visual representation of the task's status, such as a progress bar or a set of status indicators. The live feed may also include updates from the specialized agents as they work on their assigned subtasks.

At step 210, the user 102 can modify the execution of subtasks or reassign tasks to different agents at any point during the task execution process. This dynamic control allows the user 102 to adapt the task execution to their evolving needs and preferences. For example, if the user 102 finds that the subtask executed by the specialized agent does not align with the user's expectations, then the user 102 can easily request the agent to adjust their approach. This real-time adaptability ensures that the task outcomes are in line with the user's specific requirements.

At step 212, upon the successful execution of all subtasks, a comprehensive summary is presented to the user 102 for review. The presented summary encapsulates the essence of the task, encompassing the initial request, the detailed steps undertaken to accomplish the task, and the final outcomes achieved. This detailed review ensures that the user 102 is fully informed about the entire task execution process and its outcomes.

Further, at step 214, the user 102 can then approve the completion of the task and offer feedback for system's improvement and further usage. The feedback can be used to enhance the system's performance and address any potential shortcomings. By gathering user feedback, the system 100 can continuously learn and adapt to better meet the needs of its users 102 is done at step 216.

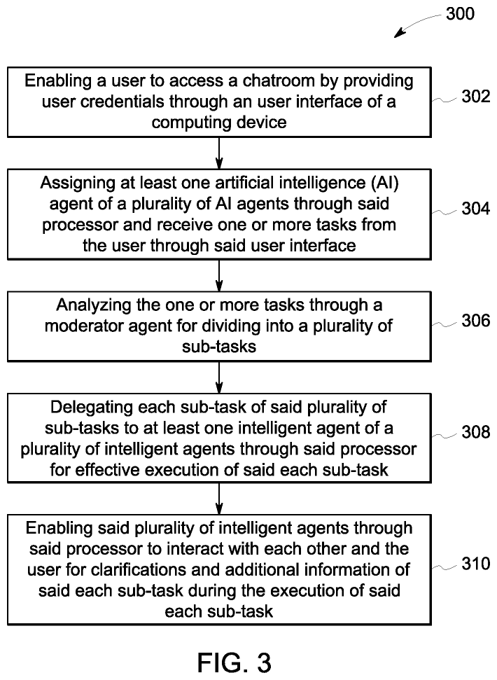

FIG. 3 refers to a flowchart 300 of a method for delegating and monitoring tasks of the chatbot using a collaborative interaction system 100. First, at step 302, the collaborative interaction system 100 enables the user 102 to access the chatroom by providing user credentials through the user interface 110 of the computing device 104. At step 304, the collaborative interaction system 100 assigns at least one artificial intelligence (AI) agent 116 through the processor 106 of the plurality of AI agents 116 and receive one or more tasks from the user 102 through the user interface 110. At step 306, the collaborative interaction system 100 analyzes the one or more tasks through the moderator agent 118 for dividing into the plurality of sub-tasks.

At step 308, the collaborative interaction system 100 delegates the each sub-task of the plurality of sub-tasks to the at least one intelligent agent of the plurality of intelligent agents 120 through the processor 106 for effective execution of the each sub-task. Further, at step 310, the collaborative interaction system 100 further enables the plurality of intelligent agents 120 through the processor 106 to interact with each other and the user 102 for clarifications and additional information of the each sub-task during the execution of the each sub-task.

In another embodiment, the collaborative interaction system 100 may utilize a voice interface instead of the chatroom interface for user-AI interaction. This makes it easy for people who are not comfortable with typing or using a mouse to interact with the collaborative interaction system 100. The virtual assistant agent serves as the moderator agent 118 for interacting with the user 102 through natural language voice commands. The virtual assistant agent interacts with the user 102 to assess tasks, create plans, and assign subtasks to specialized agents. The virtual environment provides a visual representation of the task progress and allows the user 102 to interact with the agents through voice commands or gestures.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principles of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

It will readily be apparent that numerous modifications and alterations can be made to the processes described in the foregoing examples without departing from the principles underlying the invention, and all such modifications and alterations are intended to be embraced by this application.

The claimed invention is:

1. A collaborative interaction system for delegating and monitoring tasks of a Chatbot, comprising:
a computing device having at least one processor, wherein the computing device is in communication with an application server through a network; and
a memory in communication with said processor configured to store instructions that are executable by said processor,
wherein said processor is configured to execute stored instructions to cause the collaborative interaction system to perform operations comprising:
enabling a user to access a chatroom by providing user credentials through a user interface of said computing device;
assigning at least one artificial intelligence (AI) agent of a plurality of AI agents and receive one or more tasks from the user through said user interface;
analyzing the one or more tasks through a moderator agent for dividing into a plurality of sub-tasks, wherein said moderator agent is an AI agent; and
delegating each sub-task of said plurality of sub-tasks to at least one intelligent agent of a plurality of intelligent agents for effective execution of said each sub-task.

2. The collaborative interaction system of claim 1, wherein said plurality of intelligent agents is configured to interact with each other and the user for clarifications and additional information of said each sub-task during the execution of said each sub-task, wherein said plurality of intelligent agents is the AI agents.

3. The collaborative interaction system of claim 1, wherein said collaborative interaction system enables the user to interact for altering the execution of the one or more tasks based on updates received in real-time.

4. The collaborative interaction system of claim 1, wherein said collaborative interaction system is configured to generate a summarized report for the user to approve through said user interface upon completion of said each sub-task by said plurality of intelligent agents.

5. The collaborative interaction system of claim 1, wherein said collaborative interaction system is configured to enable the user to provide a feedback through said user interface.

6. The collaborative interaction system of claim 5, wherein said feedback include haptic, visual, and auditory feedback.

7. The collaborative interaction system of claim 1, wherein said collaborative interaction system comprises:
a database in communication with said processor configured to store data related to the user.

8. The collaborative interaction system of claim 1, wherein the one or more tasks includes data related to at least one of text, images, video data, audio data, digital video data, and digital audio data.

9. The collaborative interaction system of claim 1, wherein the collaborative interaction system is configured to enable the user to upload at least one or more data files related to one or more tasks.

10. The collaborative interaction system of claim 9, wherein the one or more data files include at least one of a word document, one or more images, video files, spreadsheets, and audio files.

11. A method for delegating and monitoring tasks of a chatbot using a collaborative interaction system, comprising:
enabling a user to access a chatroom by providing user credentials through a user interface of a computing device,
wherein said computing device having at least one processor and a memory in communication with said processor configured to store instructions that are executable by said processor;
assigning at least one artificial intelligence (AI) agent of a plurality of AI agents through said processor and receive one or more tasks from the user through said user interface;
analyzing the one or more tasks through a moderator agent for dividing into a plurality of sub-tasks; and
delegating each sub-task of said plurality of sub-tasks to at least one intelligent agent of a plurality of intelligent agents through said processor for effective execution of said each sub-task.

12. The method of claim 11, wherein the method further comprises:
enabling said plurality of intelligent agents through said processor to interact with each other and the user for clarifications and additional information of said each sub-task during the execution of said each sub-task.

13. The method of claim 11, wherein said collaborative interaction system enables the user to interact for altering the execution of the one or more tasks based on updates received in real-time.

14. The method of claim 11, wherein said collaborative interaction system is configured to generate a summarized report for the user to approve through said user interface upon completion of said each sub-task by said plurality of intelligent agents.

15. The method of claim 11, wherein said collaborative interaction system is configured to enable the user to provide a feedback through said user interface.

16. The method of claim 15, wherein said feedback include haptic, visual, and auditory feedback.

17. The method of claim 11, wherein the one or more tasks includes data related to at least one of text, images, video data, audio data, digital video data, and digital audio data.

18. The method of claim 11, wherein the collaborative interaction system is configured to enable the user to upload at least one or more data files related to one or more tasks.

19. The method of claim 18, wherein the one or more data files include at least one of a word document, one or more images, video files, spreadsheets, and audio files.

20. A non-transitory computer readable medium having stored thereon computer-executable instructions which, when executed by an onboard computer of a collaborative interaction system, cause the onboard computer to:
enable a user to access a chatroom by providing user credentials through a user interface of said computing device;
assign at least one artificial intelligence (AI) agent of a plurality of AI agents and receive one or more tasks from the user through said user interface;
analyze the one or more tasks through a moderator agent for dividing into a plurality of sub-tasks;
delegate each sub-task of said plurality of sub-tasks to at least one intelligent agent of a plurality of intelligent agents for effective execution of said each sub-task; and
enable said plurality of intelligent agents to interact with each other and the user for clarifications and additional information of said each sub-task during the execution of said each sub-task.
